(19) United States
(12) Patent Application Publication
(10) Pub. No.: US 2005/0048268 A1
(43) Pub. Date: Mar. 3, 2005

(54) Relaminated ream wrap

(76) Inventor: Michael Van Abel, Kaukauna, WI (US)

Correspondence Address: Philip M. Weiss;Weiss & Weiss, 310 Old Country Road, Garden City, NY, 11530, US

(21) Appl. No.: 10/654,212

(22) Filed: Sep. 2, 2003

(51) Int. Cl. B32B 3/00

(52) U.S. Cl. 428/195.1

(57) ABSTRACT

A ream wrap material made by laminating a paper substrate to a previously manufactured ream wrap material that is printed, and methods for making such wrap material. More particularly, a re-laminated ream wrap is that which is used for packaging paper products, and the process for making such re-laminated ream wrap.

### FIELD OF THE INVENTION

The present invention relates to a ream wrap material that is made by laminating a paper substrate to a previously manufactured ream wrap material that is printed, and methods for making such wrap material. More particularly, the present invention relates to a re-laminated ream wrap that is used for packaging paper products, and the process for making such re-laminated ream wrap.

### BACKGROUND OF THE INVENTION

Reams (i.e., 500 sheets) of cut paper (8½×11, etc.) for copy machines, computers, printers, and other applications are most commonly packaged for shipping, storage, and retail sale in ream wrappers made of various wrap materials. These wrap materials traditionally have been paper (poly coated or two papers laminated with poly), plastic film, or a paper/solid plastic film combination. In addition to encasing the reams of paper, the wrap materials protect the wrapped paper product from physical damage and moisture pickup during shipping and storing. The wrap materials also protect the wrapped product from physical damage during repeated handling and stocking on retail shelves.

As retail and store distribution of reamed papers has increased, the market also has demanded that manufacturers develop wrap materials with improved printing surfaces to enhance graphics and provide an eye-appealing wrapped product for the consumer. Manufacturers have responded by producing ream wrap materials that are printed with the name and/or logos of the paper products manufacturer and other information related to the paper products encased in the ream wraps. Often the paper products manufacturer wants to change the appearance of the printed graphics of the ream wrap packaging, making obsolete any previously manufactured and printed ream wrap material that has been purchased by the paper products manufacturer or that is yet to be purchased. Rather than disposing of outdated printed ream wrap materials, paper products manufacturers have sought alternatives for reusing or re-printing such materials. By re-laminating the outdated printed ream wrap, the present invention responds to this market demand.

### SUMMARY OF THE INVENTION

The present invention relates to a ream wrapper comprising: a material comprising a paper (poly coated or two papers laminated with poly), a solid plastic film, or a paper/solid plastic film combination, that is printed on one side; laminated to a paper substrate covering said printed side of said wrapper.

The present invention relates to a ream wrapper that is made by laminating a paper substrate to the printed side of previously manufactured ream wrap products, including wrap materials that are paper (poly coated or two papers laminated with poly), plastic film, or a paper/solid plastic film combination. The present invention also relates to the method of laminating a paper substrate to the printed side of previously manufactured ream wrap products.

An object of the present invention is to create a product that makes use of previously printed ream wrap materials after the printed graphics have become outdated or were otherwise changed by the paper products manufacturer. Rather than disposing of such outdated printed ream wrap, the paper products manufacturer is able to use ream wrap materials that are re-laminated with paper covering the printed side of the ream wrap. A further object of the present invention is to create an environmentally friendly alternative to printed ream wrap materials that are outdated and would otherwise be discarded. A further object of the present invention is to provide a product that prevents physical damage and moisture pickup during shipping and storing of the reams.

A further object of the present invention is to re-laminate and then reprint ream wrap materials with outdated or obsolete graphics. Rather than discarding outdated or outmoded printed ream wrap materials that have already been purchased or have yet to be purchased from the ream wrap manufacturer, the present invention provides a ream wrap material that can be re-laminated with a paper substrate and then reprinted with updated graphics.

It is an object of the present invention to relaminate over the printed side to create a generic plain white or colored outer wrapper. It is an object of the present invention for the laminated sheet to mask obsolete printed graphics.

It is an object of the present invention to provide a process which laminates a paper having a basis weight of about 10 to 30 lbs/3,000 sq. ft. to returned customer material which has a basis weight of about 40-60 lbs/3,000 sq. ft. with about 7-10 lbs. of polyethylene. It is an object of the present invention for the laminated sheet to be white, natural or colored. It is an object of the present invention for the adhesive used to laminate the two sheets to include, but not be limited to glue, hot melts, thermal-set plastics, or poly. It is an object of the present invention for the laminated sheet to be printed.

It is an object of the present invention for the paper substrate to be either white (bleached), brown (unbleached), tan (semi-bleached), or colored or dyed with pigment. It is an object of the present invention for the paper substrate to be laminated with either poly or an adhesive to the previously printed side of the ream wrapper. It is an object of the present invention for the paper substrate to be laminated with either clear or pigmented (color or dye added) poly or adhesive and the paper substrate covers the printing on the printed side of the ream wrapper.

### DETAILED DESCRIPTION OF THE INVENTION

The present invention relates to a ream wrapper that comprises a paper (poly coated or two papers laminated with poly), plastic film, or a paper/film combination that is printed and then relaminated on the printed side with a paper substrate to cover the printed graphics. The paper substrate laminated to the printed ream wrap product can be white (bleached), brown (unbleached), semi-bleached (tan), or colored or pigmented. The preferred weight of the paper substrate laminated to the printed side of the ream wrapper is 10 to 30 lbs per 3,000 sq. ft. The paper substrate can be laminated with either poly or an adhesive to the printed side of the ream wrapper, resulting in a product that is non-printed on both sides. The laminate, whether poly or adhesive, can be either clear or pigmented with color added to the adhesive or the poly to cover the printing underneath the paper substrate.

In one embodiment of the present invention, the paper substrate is laminated to the printed side of the outdated ream wrap material and covers the outdated graphics, resulting in a ream wrap product that is plain and non-printed on both sides.

In another embodiment of the present invention, the paper substrate is laminated to the printed side of the outdated ream wrap material, resulting in a ream wrap product that is plain and non-printed on both sides. The resulting plain, non-printed ream wrap is then re-printed on one side with updated graphics.

1. A ream wrapper comprising:
a material comprising a paper (poly coated or two papers laminated with poly), a solid plastic film, or a paper/solid plastic film combination, that is printed on one side; laminated to a paper substrate covering said printed side of said wrapper.

2. The ream wrapper of claim 1 wherein said paper substrate has a basis weight of about 10 to 30 lbs. per 3,000 sq. ft.

3. The ream wrapper of claim 1 wherein said material has a basis weight of about 40-60 lbs/3,000 sq. ft.

4. The ream wrapper of claim 1 wherein said material and said paper substrate are laminated with polyethylene.

5. The ream wrapper of claim 4 wherein said material and said paper substrate are laminated with about 7-10 lbs. of polyethylene.

6. The ream wrapper of claim 1 wherein said material and said paper substrate are laminated with an adhesive selected from the group consisting of glue, hot melts, thermal-set plastics, or poly.

7. The ream wrapper of claim 1 wherein said paper substrate is either white (bleached), brown (unbleached), tan (semi-bleached), or colored or dyed with pigment.

8. The ream wrapper of claim 1 wherein said paper substrate is laminated with either poly or an adhesive to said previously printed side of said ream wrapper.

9. The ream wrapper of claim 1 wherein said paper substrate is laminated with either clear or pigmented (color or dye added) poly or adhesive and said paper substrate covers said printing on said printed side of said ream wrapper.

10. The ream wrapper of claim 1 wherein said paper substrate is either non-printed or re-printed with new graphics.

11. A process for making ream wrap comprising:
laminating a paper substrate to a printed side of a previously manufactured ream wrap product.

12. The process of claim 11 further comprising:
printing on said paper substrate.

13. The process of claim 11 wherein said laminating creates a generic plain, white or colored outer wrapper.

14. The process of claim 11 wherein said laminating masks obsolete printed graphics.

15. A ream wrapper comprising:
a previously manufactured ream wrap that is printed on one side laminated to a paper substrate covering said printed side of said wrapper.
